(19) United States
(12) Patent Application Publication
(10) Pub. No.: US 2014/0098955 A1
(43) Pub. Date: Apr. 10, 2014

(54) QUANTUM ENABLED SECURITY FOR OPTICAL COMMUNICATIONS

(71) Applicants: Richard John Hughes, Los Alamos, NM (US); Charles Glen Peterson, Los Alamos, NM (US); Jane Elizabeth Nordholt, Los Alamos, NM (US); Raymond Thorson Newell, Santa Fe, NM (US)

(72) Inventors: Richard John Hughes, Los Alamos, NM (US); Charles Glen Peterson, Los Alamos, NM (US); Jane Elizabeth Nordholt, Los Alamos, NM (US); Raymond Thorson Newell, Santa Fe, NM (US)

(73) Assignee: LOS ALAMOS NATIONAL SECURITY, LLC, Los Alamos, NM (US)

(21) Appl. No.: 12/638,730

(22) Filed: Dec. 15, 2009

(51) Int. Cl. H04L 9/08

(52) U.S. Cl. CPC H04L 9/0852
USPC 380/256

(57) ABSTRACT

The present invention provides a quantum-enabled security (QES) protocol which creates a revolutionary new cybersecurity capability: quantum (single-photon) communications are integrated with optical communications to provide a strong, innate security foundation at the photonic layer for optical fiber networks or free-space optical communications. The new protocols will also allow the formation of ad hoc coalitions of users in order to deliver quantum-enabled security users between users who may not have direct quantum communications.

### STATEMENT REGARDING FEDERAL RIGHTS

This invention was made with government support under Contract No. DE-AC52-06NA25396, awarded by the U.S. Department of Energy. The government has certain rights in the invention.

### BACKGROUND OF INVENTION

This invention relates to secure communication. More particularly, the present invention relates to integrating security services into optical communications at the photonic layer.

Secure transmission of data is becoming increasingly important in society. Personal data, commercial & financial information and cryptographic keys themselves are transmitted between different locations, and it is desirable for there to be minimal (or preferably no) risk of interception. Various encryption schemes have been proposed to protect transmitted data.

An example of such a scheme is quantum cryptography, which in principle can provide completely secure transmission. Whereas most recent encryption methods rely on the difficulty of computing certain mathematical functions, quantum cryptography is based on physical phenomena. The usual purpose of quantum cryptography is to share a random data string, for use as a key in the encryption (and decryption) of sensitive messages; the encryption itself is usually carried out using a suitable algorithm. The encrypted message may then safely be transmitted over an open (non-secure) communications channel.

Quantum cryptography is an emerging technology in which two parties may simultaneously generate shared, secret cryptographic key material using the transmission of quantum states of light. The security of these transmissions is based on the inviolability of the laws of quantum mechanics and information theoretically secure post-processing methods. An adversary can neither successfully tap the quantum transmissions nor evade detection, owing to the Heisenberg uncertainty principle.

Two of the main goals of cryptography (encryption and authentication of messages) can be accomplished, with provable security, if the sender (“Alice”) and recipient (“Bob”) possess a secret random bit sequence known as “key” material. The initial step of key distribution, in which the two parties acquire the key material, must be accomplished with a high level of confidence that a third party (“Eve”) cannot acquire even partial information about the random bit sequence. If Alice and Bob communicate solely through classical messages, it is impossible for them to generate a certifiably secret key owing to the possibility of passive eavesdropping. However, secure key generation becomes possible if they communicate with single-photon transmissions using the emerging technology of quantum cryptography, or more accurately, quantum key distribution (QKD). A small amount of shared secret key material is required to perform initial authentication. See, e.g., U.S. Pat. No. 5,966,224, issued Oct. 12, 1999, to Hughes, et al., incorporated herein by reference.

The security of QKD is based on the inviolability of the laws of quantum mechanics and provably secure (information theoretic) public discussion protocols. Eve can neither “tap” the key transmissions owing to the indivisibility of quanta nor copy them faithfully because of the quantum “no-cloning” theorem. At a deeper level, QKD resists interception and retransmission by an eavesdropper because in quantum mechanics, in contrast to the classical world, the result of a measurement cannot be thought of as revealing a “possessed value” of a quantum state. A unique aspect of quantum cryptography is that the Heisenberg uncertainty principle ensures that if Eve attempts to intercept and measure Alice's quantum transmissions, her activities must produce an irreversible change in the quantum states (she “collapses the wavefunction”) that are retransmitted to Bob. These changes will introduce an error rate having a high number of anomalies in the transmissions between Alice and Bob, allowing them to detect the attempted eaves-dropping. In particular, from the observed error rate Alice and Bob can put an upper bound on any partial knowledge that an eavesdropper may have acquired by monitoring their transmissions. This bound allows the intended users to apply conventional information theoretic techniques by public discussion to distill an error-free, secret key.

Because it has the ultimate security assurance of a law of nature, quantum cryptography offers potentially attractive “ease of use” advantages over conventional key distribution schemes: it avoids the “insider threat” because key material does not exist before the quantum transmissions take place; it replaces cumbersome conventional key distribution methods whose security is based on the physical security of the distribution process; and it provides a secure alternative to key distribution schemes based on public key cryptography, which are potentially vulnerable to algorithmic advances and improved computing techniques. Thus, quantum key distribution enables “encrypted communications on demand,” because it allows key generation at transmission time over an unsecured optical communications link.

Quantum theory tells us that measurement of an observable in a system will disturb the system, in particular where two observables are described by non-commuting operators. An example of two such observables are the polarization states of a photon, for example, on the one hand, the vertical/horizontal states, and, on the other hand, the 45 degree/135 degree diagonal states. Quantum systems can be entangled, whereby the quantum states of two or more objects are linked, and remain linked even when the objects are separated from each other, even by considerable distances.

Those phenomena enable the construction of quantum communication systems that detect any attempt at eavesdropping, and, by rejecting any data contaminated by eavesdropping, allow the transmission of a key under demonstrably secure conditions. Thus, in one class of quantum encryption systems, photon polarization is used to construct the key, and bits contaminated by eavesdropping are rejected.

In another class, entangled photons are used. One of an entangled pair of photons is transmitted to a receiver. Measurements are performed on the entangled photons, at the transmitter and receiver ends of the system and the results of those experiments are used to construct a secure key.

However, at present, quantum cryptography suffers from various limitations, such as distance (due to a need for transmission of single photons), low bit rate, susceptibility to jamming, and the considerable difficulty of implementing practical, working systems. In recent years, optical communication is widely used as a high-speed large-capacity communication technology. In such an optical communication system, communication is performed by on/off of light and a large amount of photons is transmitted when light is on, failing to realize a communication system in which a quantum effect directly manifests itself.

### SUMMARY OF INVENTION

The present invention meets these and other needs by providing a quantum-enabled security (QES) protocol which will create a revolutionary new cybersecurity capability: quantum (single-photon) communications is integrated with optical communications to provide a strong, innate security foundation at the photonic layer for optical fiber networks and for free-space optical (FSO) communications.

Accordingly, one aspect of the invention is to provide a protocol for QES quantum communications which will establish shared secret random numbers between authorized users. These numbers are used to generate frequently changing secret codes to spread conventional communications in time or frequency or both. The intended recipients share the secret spreading codes with the sender, can “de-spread” the signals, and recover the data faithfully.

Another aspect of the invention is multi-party quantum communications protocols that allow the formation of ad hoc coalitions of users, with different groups' communications separated and protected through the use of orthogonal, secret spreading codes. These protocols leverage the network to deliver quantum-enabled security between users who may not have direct quantum communications.

These and other aspects, advantages, and salient features of the present invention will become apparent from the following detailed description, the accompanying drawings, and the appended claims.

### BRIEF DESCRIPTION OF THE DRAWINGS

FIG. 1 shows a typical communications protocol stack.

FIG. 2 shows a communications protocol stack which shows that QES is introduced at the photonics layer.

FIG. 3 shows combined quantum and optical nodes on a transparent optical network that incorporates optical switches and other network elements.

FIG. 4 shows an embodiment of present invention in which QES multiple tributary data streams are multiplexed onto a single fiber, using different wavelength-time “chip” sequences according to secret, quantum-generated spreading codes.

FIG. 5a shows the optics view of an embodiment of the present invention and FIG. 5b shows the electronics view of an embodiment of the present invention.

FIG. 6 shows the optical spread spectrum communications integration.

### DETAILED DESCRIPTION

Referring to the drawings in general, it will be understood that the illustrations are for the purpose of describing a particular embodiment of the invention in an optical fiber network and are not intended to limit the invention thereto.

Given the constantly evolving nature of cyberthreats, securing cyberspace is an extraordinarily difficult challenge. Hardly a day goes by without a news report or study highlighting the need for improved cybersecurity technologies to protect our economic and National security. The present invention is a new cybersecurity capability, which combines revolutionary ways to integrate the power of quantum (single photon) communications with optical communications.

The QES methodology is an entirely new way to harness the exceptionally strong security attributes of quantum communications to solve practical network security issues. By incorporating security at the photonic layer as an innate property of the system, rather than introducing it at the data or higher layers as in conventional approaches, network security will be placed on a stronger, more assured foundation. These advantages can be achieved as an overlay on existing transparent fiber network or free-space optical infrastructure.

The present invention breaks entirely new ground: quantum-enabled security (QES) for optical networks. Specifically, quantum communications protocols are integrated with optical spread-spectrum communications to provide a strong, innate security foundation at the photonic layer for optical fiber networks or free-space optical communications.

Optical fiber communications have revolutionized the way we work, live, operate computer systems and run our national infrastructure. However, the information-processing and control systems that ubiquitous computing and high-bandwidth information transfer have made possible are built on communications protocols that were implemented long before their security limitations were fully understood and appreciated. Thus today we have the ability to remotely monitor and control national infrastructure, and collect data from distant experiments, facilities or sensor systems, but do not always have adequate security assurances for the communications that enable these new capabilities. For example, optical fiber networks are typically composed of links that are not under the physical control of the intended users, and it is an under-appreciated fact that data carried on optical fiber can be “tapped” with commercially available equipment. Optical crosstalk between adjacent wavelength-division multiplexing (WDM) bands provides additional eavesdropping opportunities. And confidentiality is only one of several necessary security services: authentication and access control are equally important, but passwords and security tokens are continually proven to be inadequate against both external and internal threats.

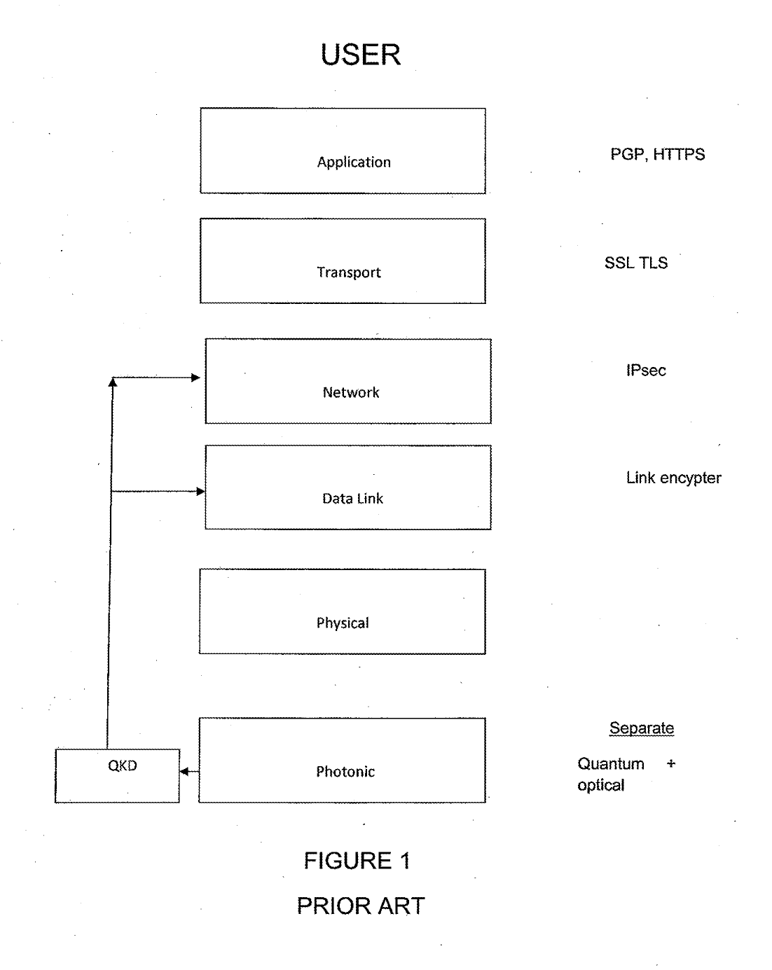

Although security has been introduced through the widespread deployment of cryptography at the data link and higher communications layers with protocols such as TLS and IPsec, cyber attacks continue to be a serious threat. FIG. 1 shows the prior art, in which security is introduced at the data link and higher levels.

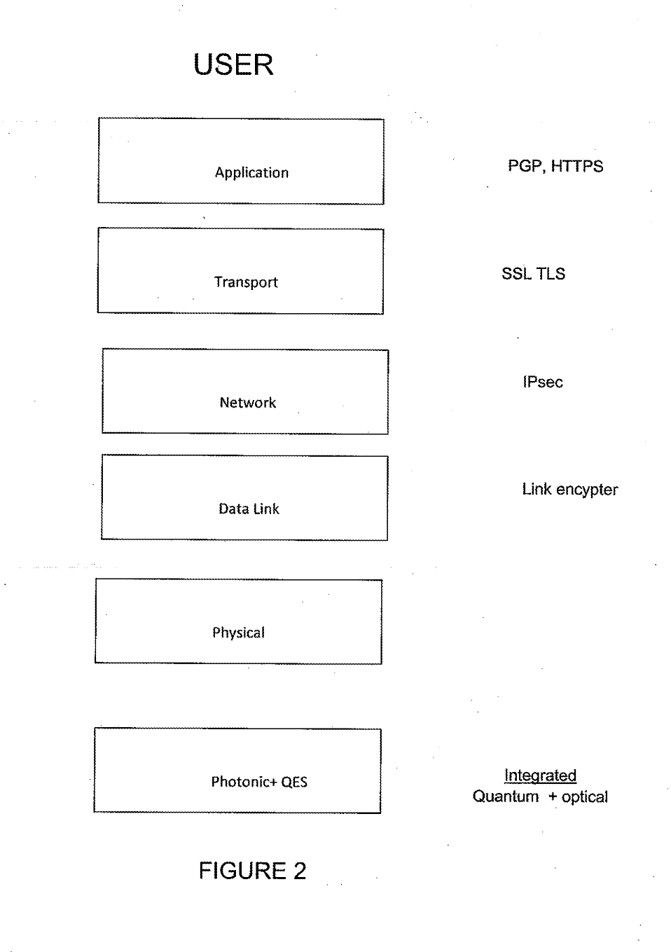

Threats to privacy posed by the potentially adversarial environment at the photonic layer are mitigated by encryption at the data link or higher layers. But owing to the prospect of quantum computers, widely-used public key methods of distributing the encryption keys do not have “forward secrecy” assurances: although secure today, public-key secured data could be tapped, archived and decrypted in the future. For this reason a major thrust of quantum communications research internationally has been directed toward QKD, which can generate unconstrained quantities of shared, secret random bits that can be used as encryption keys, with forward secrecy assurances based on laws of quantum physics. Current QKD implementations suffer several drawbacks: they require an optical fiber dedicated to QKD; they are typically only performed over a point-to-point connection; and they involve a cumbersome interface to, and key management methodology for, conventional data encryptors. In contrast to QKD as well as conventional higher-layer security protocols, in QES security is introduced as an innate ingredient of the photonic foundation as shown in FIG. 2.

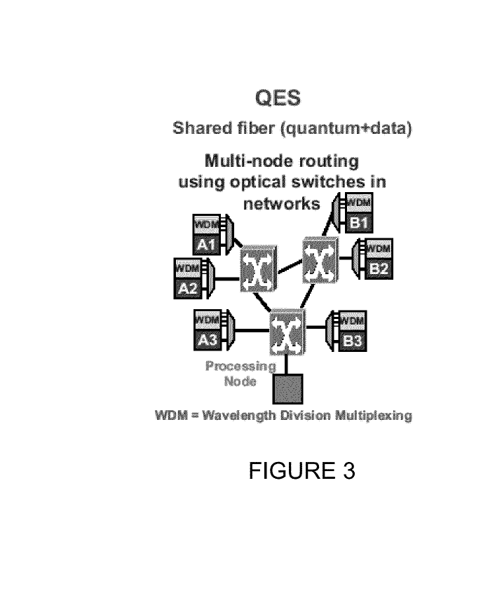

While the QKD approach is of interest for certain limited applications, there are many scenarios in which multi-level security is desired in a multi-node network, and compatibility with existing network infrastructure is essential. For example FIG. 3 shows a shared fiber which uses multiple nodes. In FIG. 3, A1-A3 and B1-B3 are combined quantum and optical nodes on a transparent optical network that incorporates optical switched and other network elements.

The present invention provides anti-tap, anti-jam, access control, anonymous routing, anonymous remote authorization and other security capabilities in transparent optical networks and free-space optical communications. It builds from results demonstrating the co-existence of quantum key distribution with conventional traffic on the same fiber in transparent networks, and traversing network elements such as wavelength selective optical switches.

The present invention will spread data (in time or frequency or both) over a large amount of signal bandwidth, and quantum communications will be used to change the spreading codes frequently, in a secure, non-deterministic way, so that any adversary would be unable to “keep up”, even in principle. This is in sharp contrast with conventional spread spectrum communications using algorithmically-generated random numbers: should the adversary diagnose the algorithm, using standard cryptanalytic methods, all future communications are insecure. An adversary's signal-to-noise ratio would thereby be forced below the threshold for successful tapping, and the data would be protected. In contrast, the intended recipients share the secret spreading codes with the sender, can “despread” the signals, and attain the high signal-to-noise ratio needed to recover the data faithfully.

In certain scenarios, the present invention would provide sufficient privacy protection in its own right, while in other scenarios it would provide defense-in-depth when combined with the security of cryptography at the data link or higher layers: by preventing the interception of encrypted data an adversary would be unable to perform an archival attack.

Another embodiment of the present invention is a multi-party quantum communications protocol that allows the formation of ad hoc coalitions of users, with different groups' communications separated and protected through the use of orthogonal, secret spreading codes. This protocol leverages the network to deliver quantum-enabled security between users who may not have direct quantum communications. In addition to enabling communications privacy between trusted network users, the present methodology offers other important security services, with capabilities beyond those possible with conventional technology, as discussed below.

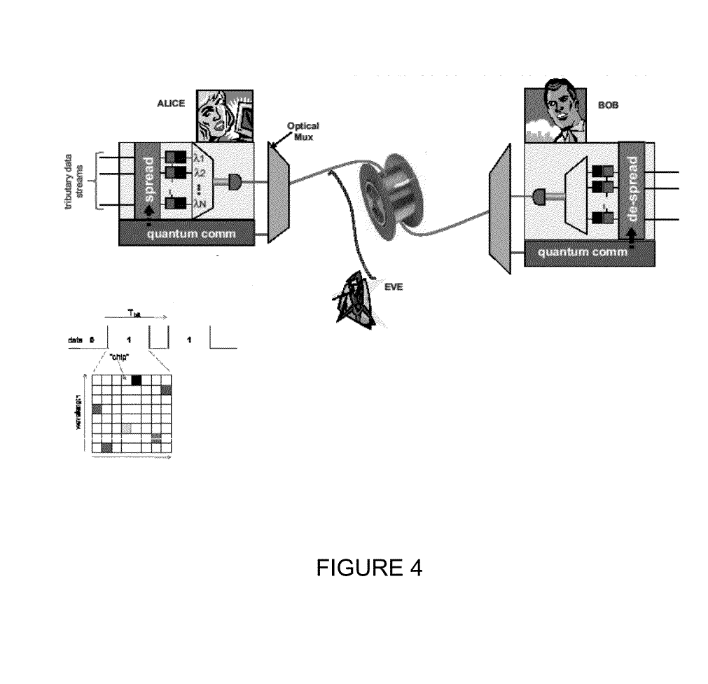

Just as optical fiber communications can be tapped, networks also offer opportunities for adversaries to introduce jamming signals for denial-of-service (DoS) attacks. The present invention can mitigate this threat by forcing an adversary to spread the available jamming power over so much optical bandwidth that the intended users can continue to communicate. The present invention inhibits traffic analysis directly at the photonic layer through its inherently anonymous routing: with several tributary data streams multiplexed onto a single fiber an adversary's ignorance of the secret spreading codes would prevent him from resolving them. This is shown in FIG. 4 in which a transmitter “Alice” spreads each data stream over a large amount of spectral and/or temporal bandwidth using secret, quantum generated spreading codes. The receiver “Bob” shares the secret, quantum-generated spreading codes and can de-spread the signals to recover Alice's data streams. However, a potential eavesdropper, “Eve” does not know the spread codes and must sample a large amount of bandwidth. This forces her signal-to-noise ratio below the threshold for tapping.

This attribute could be extremely useful in situations such as IAEA treaty monitoring, or between two US Embassy buildings where the fiber must traverse a foreign nation's territory, or in optical access networks delivering broadband services to the home or business premises. Analogously, because both traffic and its content are only visible to authorized users, anonymous remote authorization protocols could be built on top of quantum enabled security. Further, the ability to prove knowledge of the secret spreading codes offers a degree of authentication from remote network locations, protecting against impersonation and data modification or replay attacks. Strong cryptographic authentication at the data or higher layers could also be supported using a portion of the shared, secret random bits produced through quantum communications as authentication keys.

By incorporating additional quantum communications protocols into the present invention it may be extended to security scenarios with network users who are not completely trusted. Two possible protocols are quantum secret splitting and coin flipping. Quantum secret splitting utilizes quantum communication to distribute secret information among multiple parties. A possible scenario is for the President to share a launch code among Cabinet members in such a way that a certain number (either some or all of the group) must work together to reconstruct the code if the President is incapacitated. Any group of members smaller than the required threshold cannot learn anything about the distributed secret, no matter what computational resources are available. One method to carry this out is by securely establishing shared random bits with each member via quantum communications, and these bits can then be transformed into secret shares by public discussion.

Coin flipping is a security protocol where two separated and distrustful parties can agree upon a bit value selected at random, such that a dishonest participant has limited control of the output value. Any classical coin flipping protocol must rely on computational assumptions of the parties for any sense of security, but quantum coin flipping protocols can offer unconditional security (based on physical law) that either detects cheating by one party or outputs a value with a bounded amount of bias. This protocol could be utilized, for instance, in dispute resolution or whenever a random nonce is required in a cryptography protocol.

For example, quantum secret splitting protocols enforce cooperation between two or more users, and so could provide a photonic layer basis for two-party access control protocols. Quantum coin flipping could be used in scenarios such as the choice of a random nonce for use within a cryptographic protocol where cheating is a potential concern.

While revolutionary in conception, the QES methodology can be implemented as an overlay on existing optical access, campus, enterprise or metro-area transparent networks: QES can be introduced by augmenting optical transceivers at network nodes with quantum communications elements, and without the need for otherwise altering the network infrastructure. Using current technology node-to-node path lengths as large as 60 km are possible. Longer distances are feasible with next-generation superconducting single-photon detectors, and with satellite-to-ground quantum communications quantum enabled services could be extended to the continental scale or beyond. Therefore the present invention will be an attractive way to address cybersecurity needs within many existing network environments and constrained environments such as a US Embassy or a military aircraft.

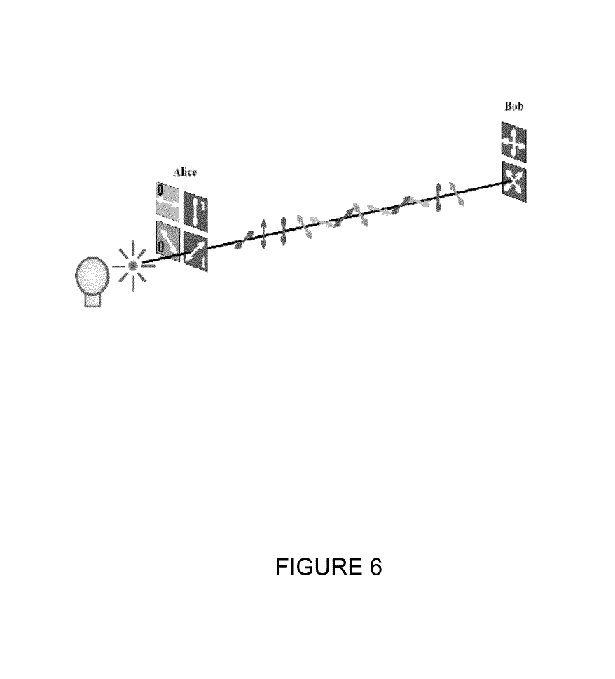

In quantum communications binary data is transmitted using two-state quantum system such as the horizontal (“H”) and vertical (“V”) rectilinear polarization states of a single photon as shown in FIG. 6 Innovative communications capabilities, impossible with classical communications, arise when coherent superpositions of these states, such as the 45° diagonal (“D”) and anti-diagonal (“A”) polarizations can be propagated without significant loss of coherence.

In one embodiment of the present invention, a secure ad hoc coalition of users who share secret spreading codes is established. In order to accomplish this, a single trusted authority (TA) has a pair-wise quantum communications link with each user, but direct user-to-user quantum communications is not assumed. Each user will use his quantum communications link to generate shared secret bits with the TA, and the TA will provide each user with a look-up table made from the pair-wise XOR of these users' secret bit strings. It is not necessary for this table to be secret, nor is it necessary for the TA to remain on-line after providing the table to the users. From the entries in this table, in combination with their own secret bit strings shared with the TA, each pair of users can now establish a shared secret to initiate spread-spectrum communications. From the two-party shared secrets, group keys can be established based on conventional multi-cast key establishment protocols. This protocol leverages the resource advantages afforded by the networking paradigm to provide QES capabilities between users who do not share direct quantum communications.

In one embodiment of the present invention, the protocol, which can be extended to provide user and data authentication, is implemented in optical fiber quantum communications systems that use highly attenuated pulses of laser light as the quantum signals, rather than genuine single-photon states.

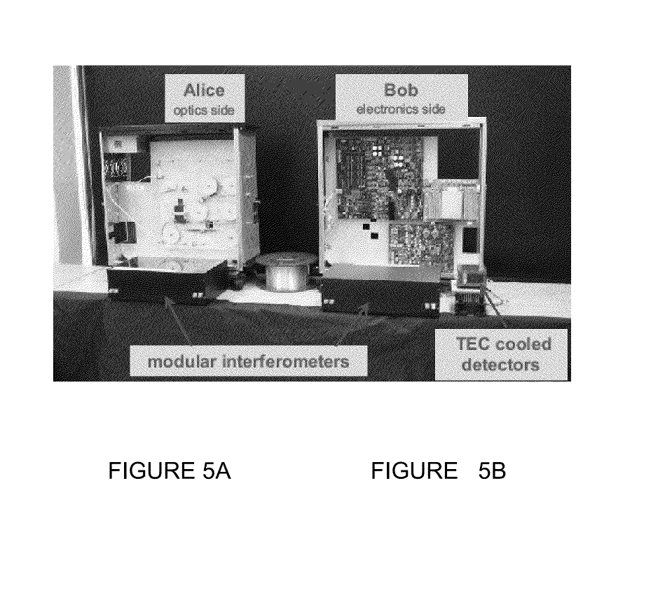

As shown in FIGS. 5a and 5b, the present invention consists of a an integrated quantum communications and wavelength division multiplexing (WDM) optical communication system that is capable of supporting quantum enabled security protocols. The networking system is based around point-to-point quantum links, to which multi-wavelength optical communications are added.

For the transmitter in this embodiment, multiple independent lasers are used, each tuned to a different WDM band, with pulse position modulation (PPM) and direct detection at the receiver, to provide a simple low-cost instantiation of the spread-spectrum methodology. Quantum communications can be performed out-of-band (at 1310 nm), or in a dedicated WDM band (1550 nm).

In one embodiment, software is used to perform the conventional communications parts of the quantum protocols using a small portion of the WDM channels' bandwidth, and to produce quantum-generated orthogonal spreading codes.

In one embodiment of the present invention, Hadamard spreading codes are used, but a variety of other possible spreading codes may be used. These will include: prime codes, orthogonal optical codes and random optical codes.

Frame synchronization, acquisition and tracking codes (e.g. Barker codes) specific to the integrated quantum and conventional communications system are used. Additionally, the present invention utilizes user authentication protocols that allow a quantum communications network to securely enroll and de-enroll users. This is a critical part of any quantum physical-layer security system.

1. A communication method comprising:
spreading one or more conventional data streams over a predetermined amount of signal bandwidth using secret quantum-generated spreading codes;
transmitting the one or more spread conventional data streams from a transmitter to a receiver over a classical communications channel comprising one of an optical fiber network or a free space optical communications link;
de-spreading the one or more spread conventional data streams in order to recover the one or more conventional data streams; and
changing the secret quantum-generated spreading codes at the transmitter and the receiver with a predetermined frequency using quantum communications.

2. The method of claim 1, wherein the one or more spread conventional data streams are communicated over an overlay network.

3. The method of claim 2, wherein the overlay network is built on top of an existing transparent optical network or free-space optical link.

4. The communication method of claim 1, wherein the one or more conventional data streams are spread over spectral bandwidth.

5. The communication method of claim 1, wherein the one or more data streams are spread over temporal bandwidth.

6. The communication method of claim 1, further comprising incorporating additional quantum protocols.

7. The communication method of claim 6, wherein the additional quantum protocols include coin flipping and quantum secret splitting.

8. (canceled)

9. (canceled)

10. (canceled)

11. A communication system comprising:
a quantum channel to generate spread conventional communications using secret quantum-generated spreading codes, the quantum channel comprising a quantum transmitter;
a conventional transmitter portion of a classical communications channel comprising multiple independent lasers wherein each laser is tuned to a different wavelength division multiplexing band;
a transmitter processor connected to the conventional and quantum transmitters, producing quantum-generated orthogonal spreading codes known only to a transmitting party and a receiving party; and
a conventional receiver portion of the classical communications channel comprising pulse position modulation and direct detection;
wherein the classical communications channel comprises one of a transparent optical network or a free-space optical link, through which the spread conventional communications are transmitted conventionally between the transmitting party and the receiving party.

12. The system of claim 11, wherein the quantum-generated orthogonal spreading codes comprise Hadamard spreading codes.

13. The system of claim 11, wherein the quantum-generated orthogonal spreading codes comprise one of prime codes, orthogonal optical codes, or random optical codes.

14. The system of claim 11, wherein the quantum channel comprises one or more out-of-band quantum links.

15. The system of claim 11, wherein the quantum channel comprises a dedicated wavelength division multiplexer.

16. (canceled)
